(19) United States
(12) Patent Application Publication
(10) Pub. No.: US 2003/0221558 A1
(43) Pub. Date: Dec. 4, 2003

(54) Apparatus and method for separation of gases

(76) Inventors: Roy D. Lister, Forth Worth, TX (US); Albert K. Solcher, Katy, TX (US)

Correspondence Address: KLAUBER & JACKSON, 411 HACKENSACK AVENUE, HACKENSACK, NJ, 07601

(21) Appl. No.: 10/396,596

(22) Filed: Mar. 25, 2003

Related U.S. Application Data
(60) Provisional application No. 60/367,889, filed on Mar. 26, 2002.

(51) Int. Cl. B01D 45/12

(52) U.S. Cl. 95/271; 55/459.1

(57) ABSTRACT

Cyclone separator apparatus for separating a gaseous mixture of a at least two respectively lighter and heavier gases. The apparatus includes a first tubular section and an elongated tubular section adjoined to the first section, which converges at a constant angle. A gaseous mixture is flowed into the interior of the first section to achieve cyclonic rotation of the mixture, the rate of which increases with the convergence at the conical section, thereby effecting separation of the lighter and heavier gas components. A lighter gas outlet is connected to the interior of the apparatus for withdrawing the lighter gas from the axial portions of the cyclone, and a heavier gas outlet is connected to the interior of the apparatus at the converged end of the conical section for withdrawing the heavier gas which the cyclonic action moves radially and which then moves toward the outlet due to a pressure drop in the apparatus.

### RELATED APPLICATIONS

This Application claims priority from U.S. Provisional Patent Application No. 60/367,889 filed Mar. 26, 2002.

### FIELD OF THE INVENTION

This invention relates generally to apparatus and methods useful in separating different gases from one another and more specifically relates to the use of a cyclone separator in order to effect the desired gas/gas separation.

### BACKGROUND OF THE INVENTION

Centrifugal force has been used to separate fluids by density in many apparatus and configurations. The prior art has been extensively developed to separate liquids and solids and liquids and gases of different densities in machines that spin to generate significant multiples of the force of gravity to accelerate the separation by density. While apparatus employing centrifugal force to separate different gases from one another are known in the prior art, the apparatus that has been used for such purposes has been successful primarily in very complex operations, as for example in the well-known use of complex centrifuging apparatus to separate isotopes of uranium.

Relatively simplified in-line type devices have also been proposed for separating gas species. For example, U.S. Pat. No. 4,859,347 discloses use of a specifically arranged converging nozzle for centrifugally separating component species of the mixture. In Example 8 of this Patent, it is suggested that separation of gases may also be feasible in the apparatus. Such example recognizes a key problem arising where an effort is made to centrifugally separate gas from gas, i.e., that the effectiveness of separation depends upon the balance of the centrifugal forces and the residence time.

U.S. Pat. No. 6,270,558 depicts a further apparatus which the patentees state can be utilized for separation of gases having different specific weights; and U.S. Pat. No. 5,453,196 discloses an induced long vortex cyclone separator which the patentee states can also be used for gas separation.

### SUMMARY OF THE INVENTION

Now in accordance with the present invention, apparatus and methods are disclosed that are effective for separating gases and/or vapors by developing forces several thousand times the force of gravity in a simple in-line configuration with essentially no moving parts. The cyclonic action provided by the invention causes the heavier components to move toward the walls of the device. This forces the lighter gas components into the center of the device. By controlling one or both of the pressures at the two resulting gas streams separation of the components can be controlled. Thus by controlling the back-pressure on the outlet for the heavier components at the tip of the vortex, the lighter components are caused to flow back up the center of the vortex. The lighter component (or components) can thus be separated toward the input end of the apparatus or alternatively may be removed at another point by withdrawing the lighter gas from the center of the vortex at another axial point. The device is of simple low cost construction and is capable of effecting relatively clean separations of gas components with different densities. The in-line configuration has a low initial cost and operation cost advantages that enable it to be a preferred device for many applications. Being of simple and lightweight design, and also being compact in nature, low maintenance is required. With no moving parts or spare part requirement it can be designed to be abrasion residence to insure years of low cost trouble free operation. The apparatus can be constructed from numerous materials to reduce cost and corrosion when necessary and to assure compatibility with the components being separated.

### BRIEF DESCRIPTION OF DRAWINGS

The invention is diagrammatically illustrated by way of example in the drawings appended hereto in which

FIG. 1 is a simplified schematic diagram showing a reverse cyclone in accordance with the invention being utilized to separate respectively heavier and lighter gases; and

FIG. 2 is a schematic elevational view similar to FIG. 1, but showing an embodiment of the invention which constitutes a straight through cyclone.

### DESCRIPTION OF PREFERRED EMBODIMENTS

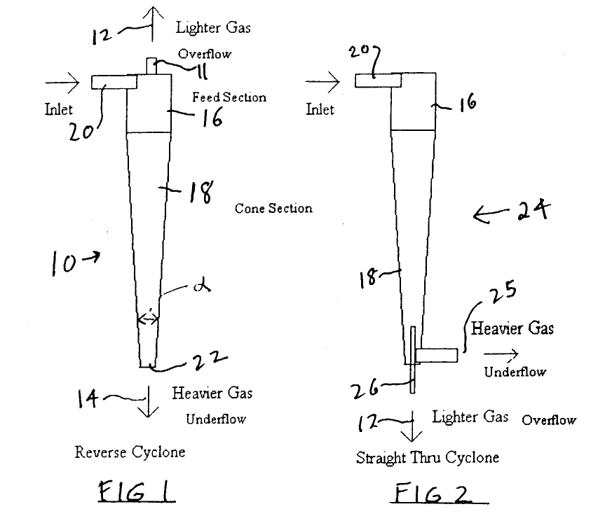

In FIG. 1 the reverse cyclone separator 10 is designed to separate a relatively lighter gas 12 from a relatively heavier gas 14. The cyclone separator 10 comprises a first tubular section 16 which is adapted to generate a cyclonic circulation in the gas mixture provided thereto. In the embodiment of FIG. 1 the section 16 has a constant cross-sectional diameter for the length thereof and is directly adjoined to a much longer, tapering conical section 18. Section 18 thus converges for its entire length at a constant angle of convergence α. It is essential in accordance with the invention to provide for high gas residence time to enable the separation when the densities of the gaseous components are relatively low. In order to achieve this residence time, a very long conical section 18 is provided. The length L of the conical section 18 is preferably at least 9 times its maximum diameter. The included cone angle α which measures the degree of tapering convergence in section 18 will typically be about 4 degrees. More generally, the included cone angle α should be less than 6 degrees, and preferably will be in the range of 3 to 5 degrees.

The gaseous mixture to be separated is provided at the tangentially connected inlet 20 where flow into the apparatus is effected by a pressure drop. Conical section 18 can have by way of example an ID of 4 inches or more (e.g. 10 inches) where the cone joins feed section 16. The conical section can typically be approximately 12 feet long, and may range to 20 feet or more in length. Inlet gas velocity at inlet 20 (for the gaseous mixture) should be high, for example should be at least 40 ft/sec where a representative inlet cross-sectional area of 0.034 square feet is assumed. A ratio that is significant here is that of the diameter Dᵢ of the gas inlet 20 to the maximum diameter Dₒ of the cone section 18. This ratio (Dᵢ/D_{c}) should preferably be between 0.2 and 0.5. The gaseous mixture proceeding through inlet 20 is oriented for flowing the gaseous mixture into the interior of section 16 tangential to the inner wall thereof, to thereby achieve cyclonic rotation of the mixture at a rate which increases with the convergence at section 18, thereby effecting separation of the lighter and heavier gas components. The lighter gas 12 is withdrawn from the axial portions (or/center) of the developed cyclone, such as at outlet 11. The heavier gas component is driven by the cyclone to off axis points, i.e., toward the outer wall of apparatus 10, and flows by pressure drop through section 18 toward the converged edge thereof where it is drawn off at outlet 22. The overflow diameter/maximum cone diameter (Dₒ/D_{c}) should preferably be between 0.1 and 0.3. One or more control valves (not shown) may be provided at the underflow and/or overflow outlets 22 and 12 to assist in controlling and adjusting the flow rates of the two exiting streams. The separator 10 of the invention may be one of a plurality of such devices, which can be connected either in series or in parallel depending upon the application required.

The further embodiment of the invention shown in FIG. 2 is similar in operation to that of FIG. 1 and has similar parameters, with common parts being correspondingly identified. The device of FIG. 2 differs primarily in being a “straight through” cyclone 24 rather than a “reverse” cyclone 10. Specifically, it will be seen in this instance that the heavier gas outlet 25 is at the distal end of conical section 18, at one side thereof. Outlet 25 can be adjusted in the lateral degree to which it extends toward the apparatus axis, depending upon the densities of the gases to be separated. A tube 26 is inserted at the distal end of conical section 18 so that the open end of the tube 26 is in contact with the axial vortex that develops within the cyclone during use. It is at this vortex that the lighter component is present as the separation proceeds and thus the lighter gas 12 may in this embodiment be drawn off directly at the distal end of section 18 via tube 26 which provides an outlet for the lighter gas. The tube 26 can be adjusted so that its gas inlet is located at a desired point along the length of section 18, partially with the objective of removing the lighter component with little or no turbulence. The heavier component may also be drawn off directly or toward the end of section 18. The tube 26 used to withdraw the light ends may also exit from the side.

Depending upon operating conditions and the gas mixture being processed, the components of the bas mixture flowing through the present separator may condense into liquids due to the Joule-Thompson effect of the pressure drop through the device or to the changes in component compositions due to the separation caused by the centrifugal forces generated by the device. Any liquid formed will be denser than the gas components and will be driven to the walls of the device. This liquid can be separated or can be allowed to exit with the heavier gas components and can be separated from the heavier gases externally to the device. This effect, i.e. liquefaction, can provide a further low cost separation enabled by the present apparatus.

While the present invention has been described in terms of specific embodiments thereof, it will be understood in view of the present disclosure, that numerous variations upon the invention are now enabled to those skilled in the art, which variations yet reside within the scope of the present teaching. For example, while the invention is especially applicable to separation of gases, it is also possible to utilize the apparatus and method for separation of other fluids, such as liquids from liquids, (e.g., water from oil). Accordingly, the invention is to be broadly construed, and limited only by the scope and spirit of the claims now appended hereto.

What is claimed is:

1. Cyclone separator apparatus for separating a gaseous mixture of a at least two respectively lighter and heavier gases; comprising
a first tubular section having an inlet for said gaseous mixture, said section being adapted to induce a cyclonic flow in the gaseous mixture;
an elongated conical section adjoined directly to said first section and receiving the established cyclonic flow, said conical section converging from top to bottom at a constant angle of convergence to achieve cyclonic rotation of the said gaseous mixture at a rate which increases with the convergence at said conical section, thereby effecting separation of said lighter and heavier gas components;
a lighter gas outlet connected to the interior of said apparatus for withdrawing said lighter gas from the axial portions of the developed cyclone; and
a heavier gas outlet connected to the interior of said apparatus at the converged end of said tapered section for withdrawing said heavier gas which the cyclonic action moves radially off the axis of said first and conical sections and which due to pressure drop flows in said apparatus toward said outlet.

2. Apparatus in accordance with claim 1 wherein the lighter gas outlet is aligned with the apparatus axis.

3. Apparatus in accordance with claim 2 wherein the lighter gas outlet is at the end of said first section remote from said conical section and is in communication with the interior axis thereof.

4. Apparatus in accordance with claim 2 wherein said lighter gas outlet is at the converged end of said conical section and intrudes into the interior of said conical section along the axis thereof so as to withdraw said lighter gas from axial points spaced from the end of said conical section.

5. Apparatus in accordance with claim 1, wherein said heavier gas outlet is at the converged end of said conical section.

6. Apparatus in accordance with claim 5, wherein said heavier gas outlet passes through the sidewall of said converged section adjacent to the converged end thereof to withdraw said heavier gas from off axis points in said conical section.

7. Apparatus in accordance with claim 1 wherein the conical section has an axial length of at least 9 times the maximum diameter of said section.

8. Apparatus in accordance with claim 7, wherein the angle of convergence of said conical section is in the range of 3 to 6 degrees.

9. Apparatus in accordance with claim 8 wherein said angle of convergence is in the range from 3 to 5 degrees.

10. Apparatus in accordance with claim 1, further including valve means to enable adjustment of the outward flow rates of the two or more gas components.

11. Apparatus in accordance with claim 8, wherein the ratio of the diameter of the gas inlet to the maximum diameter of the said conical section is between 0.2 and 0.5.

12. Apparatus in accordance with claim 1, wherein the outlet diameter where said heavier gas emerges has a diameter ratio to the maximum diameter of said conical section between about 0.1 and 0.3.

13. A method for separating a gaseous mixture of at least two respectively lighter and heavier gases, comprising:
establishing a cyclonic flow of the gaseous mixture into the wide end of an elongated tapering tube having an outlet at its narrow end, whereby the cyclonic flow of said gaseous mixture through the tube is at a velocity which increases with the convergences of said tube, thereby effecting separation of said lighter and heavier gas components;
withdrawing and thereby separating said heavier gas which the cyclonic action moves radially outward from the axis of said tube; and
withdrawing and thereby separating said lighter gas from the center of the developed cyclone.

14. A method in accordance with claim 13, wherein the gaseous mixture is flowed into said tube at a velocity of at least 40 feet/sec.

15. A method in accordance with claim 14, wherein said tapered tube length is at least 9 times its maximum diameter.

16. A method in accordance with claim 17 wherein the said tube tapers at an included angle of from 3 to 6 degrees.
